(19) United States
(12) Patent Application Publication
(10) Pub. No.: US 2019/0184665 A1
(43) Pub. Date: Jun. 20, 2019

(54) SELF ADJUSTING STITCHING WHEEL

(71) Applicant: BARTELL MACHINERY SYSTEMS, L.L.C., Rome, NY (US)

(72) Inventor: John Robert Russo, II, Marcy, NY (US)

(73) Assignee: BARTELL MACHINERY SYSTEMS, L.L.C., Rome, NY (US)

(21) Appl. No.: 16/211,613

(22) Filed: Dec. 6, 2018

Related U.S. Application Data
(60) Provisional application No. 62/598,741, filed on Dec. 14, 2017.

(51) Int. Cl. B29D 30/50

(52) U.S. Cl. CPC B29D 30/50; B29D 2030/481

(57) ABSTRACT

A system for stitching a bead apex includes an upper assembly including an upper elongated member, an upper arm coupled to the upper elongated member, and an upper stitching wheel coupled to the upper arm. The system also includes a lower assembly including a lower elongated member, a lower arm coupled to the lower elongated member, and a lower stitching wheel coupled to the lower arm. The upper assembly further includes a non-locking actuator coupled to the upper arm, wherein the non-locking actuator is configured to move the upper arm about the first pivot point to move the upper stitching wheel to an operative configuration, wherein the non-locking actuator is configured to permit movement of the upper stitching wheel in a Y-direction between at least a first position and a second position while in the operative configuration

### PRIORITY CLAIM

This invention claims the benefit of priority of U.S. Provisional Application Ser. No. 62/598,741, entitled “Self Adjusting Stitching Wheel,” filed Dec. 14, 2017, the disclosure of which is hereby incorporated by reference in its entirety.

### BACKGROUND

The present embodiments relate generally to systems and methods for stitching a bead apex to a bead ring, in an improved manner.

Many types of vehicular tires include beads surrounding the openings that engage the wheel rim. In general, beads comprise a wire coil in the nature of a hoop formed by winding multiple turns of a coated wire on a suitable bead forming apparatus. The bead may be made up of multiple, radially and axially arranged turns of a single wire or, in so-called weftless beads, of radially stacked layers of a flat ribbon including a plurality of side-by-side wires.

Techniques have been used for applying a bead apex to the peripheral surface of a bead ring. In general, the bead apex is formed by extrusion of a material to a relatively thin shape, which is then is maneuvered and applied to the peripheral surface of a bead ring, often times by stitching the bead apex to the bead ring via stitching wheels. However, current stitching wheels are difficult to adjust to different sized bead apexes and bead rings, thereby making it difficult and time consuming when adjustments are necessary.

### SUMMARY

In one form of the present disclosure, a system for stitching a bead apex to a bead ring is provided. The system comprises a frame and an upper assembly coupled to the frame, wherein the upper assembly comprises an upper elongated member, an upper rotatable arm coupled to the upper elongated member, wherein the upper rotatable arm is rotatable about a first pivot point with respect to the upper elongated member, and an upper stitching wheel coupled to the upper rotatable arm. The system also comprises a lower assembly coupled to the frame, wherein the lower assembly comprises a lower elongated member, a lower rotatable arm coupled to the lower elongated member, wherein the lower rotatable arm is rotatable about a second pivot point with respect to the lower elongated member, and a lower stitching wheel coupled to the lower rotatable arm. In addition, the upper stitching wheel and lower stitching wheel comprise an operative configuration, wherein in the operative configuration the upper stitching wheel is configured to engage with a first surface of the bead apex and the lower stitching wheel is configured to engage with a second surface of the bead apex. Further, the upper assembly further comprises a non-locking actuator coupled to the upper rotatable arm, wherein the non-locking actuator is configured to rotate the upper rotatable arm about the first pivot point to move the upper stitching wheel to the operative configuration, wherein the non-locking actuator is configured to permit movement of the upper stitching wheel in a Y-direction between at least a first position and a second position while in the operative configuration.

The system may also include the upper and lower stitching wheels further comprising a released configuration, wherein in the released configuration the upper and lower stitching wheels are rotated away from each other, and in the operative configuration, the upper and lower stitching wheels are rotated towards each other. The upper stitching wheel may also be adjustable in an X-direction and a θ-direction while in the released configuration, wherein the upper stitching wheel is locked and not adjustable in the X-direction and the θ-direction while in the operative configuration. In addition, the lower stitching wheel may be adjustable in an X-direction, a Y-direction, and a θ-direction while in the released configuration, wherein the lower stitching wheel is locked and not adjustable in the X-direction, the Y-direction, and the θ-direction while in the operative configuration. Further, the non-locking actuator may comprise a pneumatic cylinder, wherein introduction of a gas into the pneumatic cylinder moves the upper stitching wheel from the released configuration to the operative configuration and removal of the gas from the pneumatic cylinder moves the upper stitching wheel from the operative configuration to the released configuration. Also, in the operative configuration, the pneumatic cylinder may be configured to permit movement of the upper stitching wheel in the Y-direction between at least the first position and the second position. The system may further comprise an air pressure regulator, wherein the air pressure regulator is configured to control the amount of the gas introduced into the pneumatic cylinder and removed from the pneumatic cylinder.

In another form of the present disclosure, a system for stitching a bead apex to a bead ring is provided. The system comprises a frame and an upper assembly coupled to the frame, wherein the upper assembly comprises an upper elongated member, an upper rotatable arm coupled to the upper elongated member, wherein the upper rotatable arm is rotatable about a first pivot point with respect to the upper elongated member, and an upper stitching wheel coupled to the upper rotatable arm. The system also comprises a lower assembly coupled to the frame, wherein the lower assembly comprises a lower elongated member, a lower rotatable arm coupled to the lower elongated member, wherein the lower rotatable arm is rotatable about a second pivot point with respect to the lower elongated member, and a lower stitching wheel coupled to the lower rotatable arm. In addition, the upper assembly further comprises an actuator, wherein the actuator is configured to apply a variable downward Y-direction force to the upper stitching wheel, wherein when the downward force applied to the upper stitching wheel by the actuator is increased, the upper stitching wheel is configured to move down in the Y-direction, wherein when the downward force applied to the upper stitching wheel by the actuator is decreased, the upper stitching wheel is configured to move up in the Y-direction.

In yet another form of the present disclosure, a method for adjusting the height of a stitching wheel is provided. The method comprises providing a system comprising a frame, an upper assembly coupled to the frame, and a lower assembly coupled to the frame, wherein the upper assembly comprises an upper elongated member, and upper rotatable arm coupled to the upper elongated member, wherein the upper rotatable arm is rotatable about a first pivot point with respect to the upper elongated member, and an upper stitching wheel coupled to the upper rotatable arm, wherein the lower assembly comprises a lower elongated member, a lower rotatable arm coupled to the lower elongated member, wherein the lower rotatable arm is rotatable about a second pivot point with respect to the lower elongated member, and a lower stitching wheel coupled to the lower rotatable arm. The method further comprises moving the upper stitching wheel from a released configuration to an operative configuration by rotating the upper rotatable arm with a non-locking actuator, wherein in the operative configuration the upper stitching wheel is configured to engaged with a first surface of a bead apex. In addition, the method comprises adjusting the height of the upper stitching wheel while the upper stitching wheel is in the operative configuration.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic perspective view of selected components of a system for stitching a bead apex to a bead ring, with upper and lower arms in a released configuration;

FIG. 2 is a perspective view of the system of FIG. 1 with the upper and lower arms in an operative configuration;

FIG. 3 is a side view of the system of FIGS. 1-2 with the upper and lower arms in an operative configuration and engaged with a bead apex;

FIG. 4 is a side view of the system of FIGS. 1-2 with the upper and lower arms in an operative configuration and engaged with a different sized bead apex; and

FIG. 5 is a perspective view of additional components of a system for stitching a bead apex to a bead ring.

### DETAILED DESCRIPTION OF THE PREFERRED EMBODIMENTS

Referring to the drawings, a system 20 for stitching an exemplary bead apex 80 is shown and described. The system 20 may comprise an upper assembly 30 and a lower assembly 40, which are used attach the bead apex 80 to a bead ring 82, as described further below.

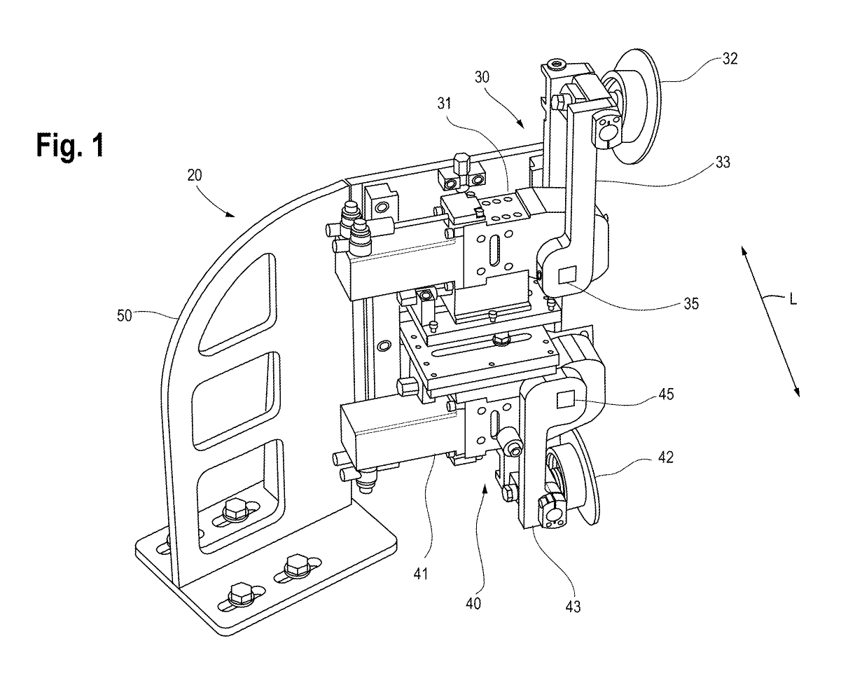

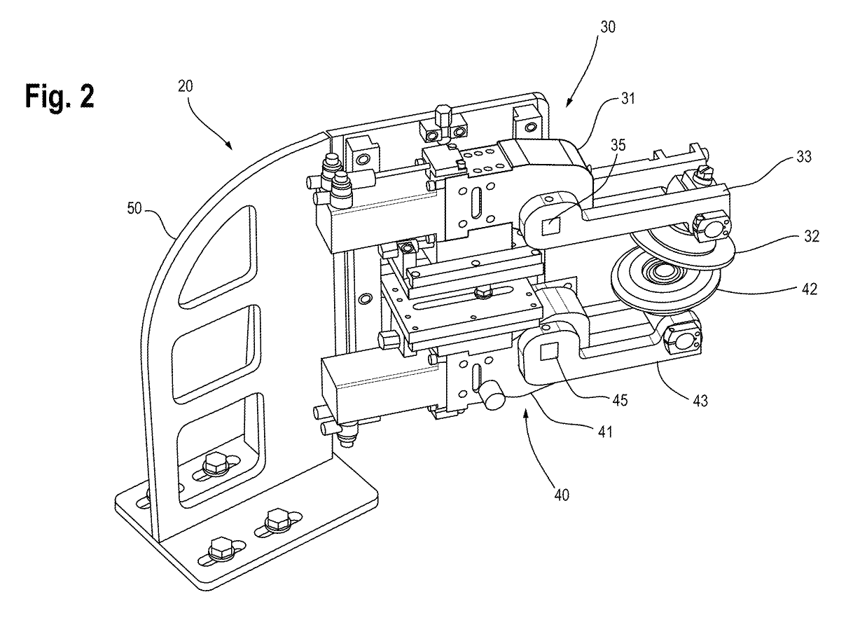

The upper assembly 30 may generally comprise an elongated main body 31, an upper stitching wheel 32, and an upper rotatable arm 33, as shown in various views and stages between FIGS. 1-4. The upper rotatable arm 33 may be rotatable with respect to the elongated main body 31 about pivot point 35 between the positions shown in FIGS. 1 and 2. The upper stitching wheel 32 may be connected to an end of, and rotatable with respect to, the upper rotatable arm 33. The lower assembly 40 may generally comprise an elongated main body 41, a lower stitching wheel 42, and a lower rotatable arm 43. The lower rotatable arm 43 may be rotatable with respect to the elongated main body 41 about pivot point 45 between the positions shown in FIGS. 1 and 2. The lower stitching wheel 42 may be connected to an end of, and rotatable with respect to, the lower rotatable arm 43.

The upper and lower assemblies 30 and 40 may be coupled to a frame 50. The frame 50 may comprise any suitable shape. In this non-limiting example, the frame 50 is generally vertically oriented relative to the ground, but other configurations are possible. A suitable actuation mechanism may be used to effect rotation of the upper and lower arms 33, 43 about their respective pivot points 35, 45.

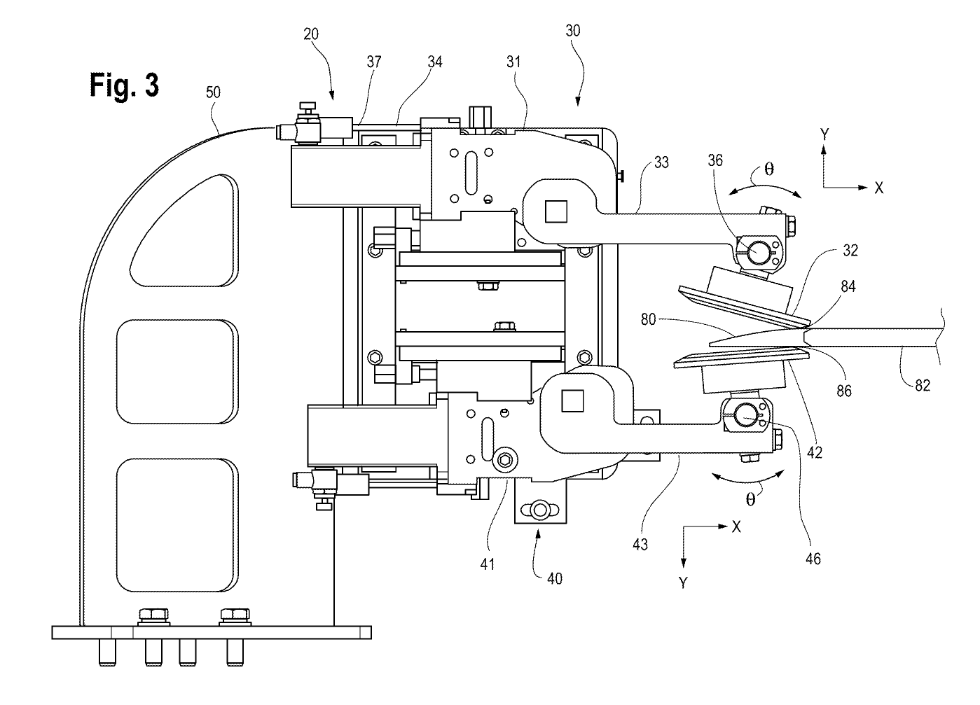

Referring to FIG. 1, both the upper and lower arms 33, 43 are shown in open states, or a released configuration, in which they are each spaced apart from an axis L defined by a pathway of the bead apex 80 (shown in FIG. 3). The upper arm 33 is depicted as being rotated about 90 degrees above the axis L in the open state, while the lower arm 43 is depicted as being rotated about 90 degrees below the axis L in the open state, but it will be appreciated that either of the arms 33, 43 may be rotated greater or lesser amounts with respect to the axis L in their respective open states.

Referring to FIG. 2, the lower arm 43 is shown in a closed state, or operative configuration, in which it is rotated circumferentially upward, about the pivot point 45, such that the lower arm 43 is substantially adjacent to a pathway of the axis L defined by the bead apex 80 (shown in FIG. 3). In addition, the upper arm 33 is shown in a closed state, or operative configuration, in which it is rotated circumferentially downward, about the pivot point 35, such that the upper arm 33 is substantially adjacent to a pathway of the axis L defined by the bead apex 80 (shown in FIG. 3).

In the operative configuration shown in FIG. 2, the upper and lower stitching wheels 32, 42 are configured to engage with the bead apex 80 near the contact point between the bead apex 80 and the bead ring 82, as shown in FIG. 3. In this state, the upper stitching wheel 32 may engage a top surface 84 of the bead apex 80, while the lower stitching wheel 42 may engage a bottom surface 86 of the bead apex 80. When the stitching wheels 32, 42 come into contact with the respective surfaces 84, 86 of the bead apex 80, they apply a compressive force to the bead apex 80. This pressure causes the bead apex 80 and bead ring 82 to bond via the natural adhesive quality of the bead apex 80 and bead ring 82. It is essential to the bonding process that the stitching wheels 32, 42 apply an appropriate amount of pressure to the bead apex 80. Applying too much pressure may result in the bead apex 80 becoming jammed within the system 20 and damage to the bead apex 80. Conversely, if too little pressure is applied the bead apex 80 may not properly bond to the bead ring 82. Thus, in order to apply the appropriate force to bond the bead apex 80 and bead ring 82 together, the stitching wheels 32, 42 are ideally adjustable in an X-direction, Y-direction, and θ-direction.

Referring to FIG. 3, each stitching wheel 32, 42 may be individually adjusted in a Y-direction, X-direction, and θ-direction. In one non-limiting example, the stitching wheels 32, 42 may be adjusted in the X-direction by sliding elongated members 31, 41 along a rail (not shown) with respect to the frame 50. In addition, the elongated members 31, 41 may be locked in the X-direction by various locks (not shown) well known in the art. Alternatively, the elongated members 31, 41 (and by extension the stitching wheels 32, 42) may be adjusted in the X-direction using a motor or any other adjustment mechanism commonly known in the art. Also, rather than adjusting the elongated members 31, 41, the rotatable arms 33, 43 or the stitching wheels 32, 42 themselves may be adjusted with respect to the rest of the upper and lower assemblies 30, 40, respectively.

The upper stitching wheel 32 may be adjusted in the θ-direction by rotating the upper stitching wheel 32 with respect to the rotatable arm 33 via pivot point 36. Similarly, the lower stitching wheel 42 may be adjusted in the θ-direction by rotating the lower stitching wheel 42 with respect to the rotatable arm 43 via pivot point 46. The lower stitching wheel 46 may be adjusted in the Y-direction by adjusting the amount the lower arm 43 rotates to reach the operative configuration.

Typically, these adjustments are made while the upper and lower stitching wheels 32, 42 are in their open state, or released configuration. Once the upper and lower stitching wheels 32, 42 are rotated into the operative configuration, the upper and lower stitching wheels 32, 42 are typically locked into place to prevent unwanted movement—thereby also preventing any additional adjustments of the upper and lower stitching wheels 32, 42. If additional adjustments are desired, the operator must unlock the upper and lower stitching wheels 32, 42 prior to making any adjustments. Thus, additional adjustments to the positions of the upper and lower stitching wheels 32, 42 once in the operative configuration can be time consuming and inefficient.

In practice, once the lower stitching wheel 42 is adjusted to fit the particular system 20, it should not require any adjustments in the Y-direction and θ-direction with only minimal adjustments in the X-direction to adjust for different size changes in either the profile of the bead apex 80 or the diameter of the bead ring 82. Similarly, once the upper stitching wheel 32 is adjusted to fit the particular system 20, it should require only minimal adjustments in the X-direction and θ-direction. However, each time the profile height of the bead apex 80 and bead ring 82 change, the upper stitching wheel 32 must be adjusted in the Y-direction or else risk the bead apex 80 and bead ring 82 not properly bonding. Traditional stitching wheel assemblies use the same Y-direction adjustment mechanism as described here with respect to the lower stitching wheel 42 to adjust the upper stitching wheel 32 in the Y-direction, and then lock the upper stitching wheel 32 in the operative configuration, thereby preventing any further adjustments. However, due to the more frequent Y-direction adjustments necessary for the upper stitching wheel 32, it can be difficult and time consuming to unlock and then adjust the upper stitching wheel 32 every time there is a change in the profile height of the bead apex 80 and bead ring 82.

Thus, the present embodiment includes an upper stitching wheel 32 that may automatically adjust in the Y-direction based on the profile height of the bead apex 80 and bead ring 82. While the upper stitching wheel 32 is locked into position while in the operative configuration such that the upper stitching wheel 32 cannot move in the X-direction and θ-direction, the upper stitching wheel 32 is not locked in the Y-direction. Instead, while in the operative configuration, the upper arm 33, and by extension the upper stitching wheel 32, may move freely up and down in the Y-direction as desired via a non-locking actuator 34. The actuator 34 is configured to apply a variable force to the upper arm 33. When the force applied to the upper arm 33 by the actuator 34 is increased, the upper arm 33 rotates downward further and thus the upper stitching wheel 32 also moves down in the Y-direction and/or increases the pressure applied to the bead apex 80, depending on the profile of the given bead apex 80. When the force applied to the upper arm 33 by the actuator 34 is decreased, the upper arm 33 rotates upward and thus the upper stitching wheel 32 moves up in the Y-direction and/or decreases the pressure applied to the bead apex 80, depending on the profile of the given bead apex 80.

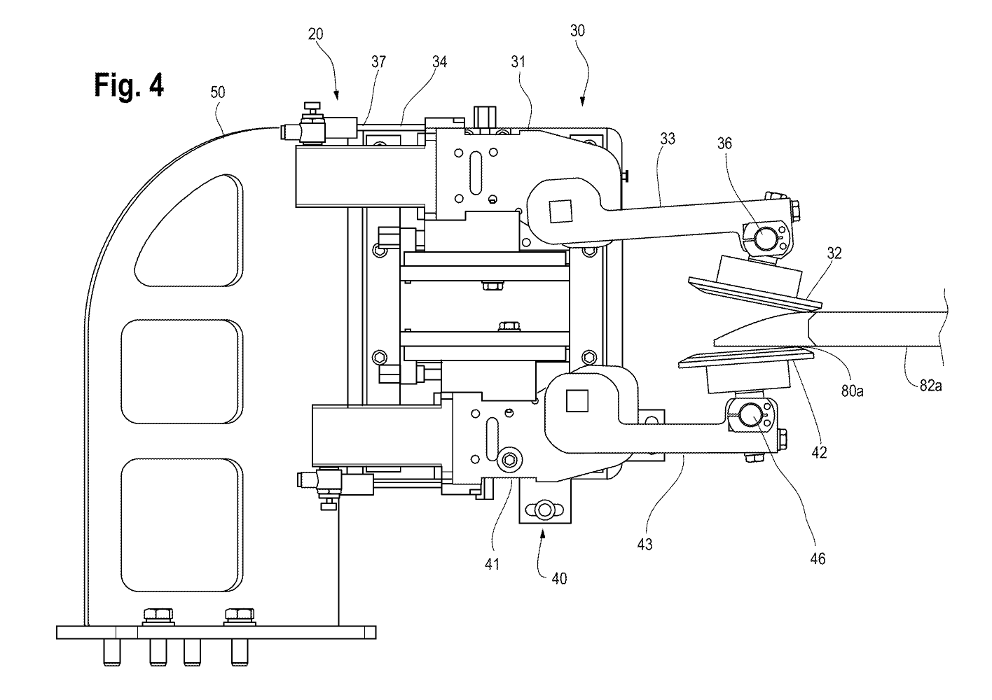

The non-locking actuator 34 allows for the upper stitching wheel 32 to remain unlocked in the Y-direction while in the operative configuration, thereby allowing the height of the upper stitching wheel 32 in the Y-direction to be easily adjusted for varying sized bead apexes. Additionally, the height of the upper stitching wheel 32 can be adjusted in the Y-direction while the upper stitching wheel 32 remains in the operative configuration. For example, FIGS. 3 and 4 both show the upper and lower stitching wheels 32, 42 in an operative configuration where they are engaged with a thinner bead apex 80 (FIG. 3) or a thicker bead apex 80a (FIG. 4). In traditional designs, if an operator wanted to switch the system 20 from the thinner bead apex 80 to the thicker bead apex 80a, the operator would need to manually adjust the height of the upper stitching wheel 32 in the Y-direction to accommodate the thicker bead apex 80a. However, the present embodiment eliminates the need for this manual adjustment. Instead, because the non-locking actuator 34 does not lock the height of the upper stitching wheel 32, the upper stitching wheel 32 will automatically adjust to accommodate the thicker bead apex 80a.

The non-locking actuator 34 may include a variety of different devices that allow quick and simple adjustment of the upper stitching wheel 32 in the Y-direction. In the present embodiment, the non-locking actuator 34 includes a pneumatic cylinder 37, which uses pressurized air to rotate the upper arm 33 from the released configuration to the operative configuration as well as adjust the height of the upper stitching wheel 32 in the Y-direction. When in the operative configuration, the pneumatic cylinder 37 is configured to permit movement of the upper stitching wheel 32 in the Y-direction within a certain acceptable range. Regardless of the specific position of the upper stitching wheel 32 in the operative configuration, the pneumatic cylinder 37 continues to apply a force pushing the upper stitching wheel 32 in a downward Y-direction, thereby ensuring that sufficient pressure is applied by the upper stitching wheel 32 to the bead apex 80.

While it is not always necessary with the present embodiment, the air pressure of the pneumatic cylinder 37 may be increased or decreased while in the operative configuration to adjust the amount of force applied to the bead apex 80 by the upper stitching wheel 32. A pressure regulation device (not shown) may be used to quickly and easily vary the pressure of the pneumatic cylinder 37 as necessary, thereby decreasing the amount of downtime when switching to bead apexes and rings of heights.

While the present embodiment utilizes an air pressure system and pneumatic cylinder 37 to automatically adjust the upper stitching wheel 32 in the Y-direction, other systems that also can automatically adjust may be utilized as well, including, but not limited to, hydraulics and springs. For example, a hydraulic cylinder may be used in place of the pneumatic cylinder, where introduction and removal of a fluid from the hydraulic cylinder may adjust the height of the upper stitching wheel 32 in the Y-direction as well as control the amount of force applied by the upper stitching wheel 32 to the bead apex 80. In addition, the hydraulic cylinder may permit movement of the upper stitching wheel 32 in the Y-direction while in the operative configuration. Similarly, a spring may be used in place of the pneumatic cylinder, where the force applied by the spring to the upper stitching wheel 32 may be adjustable to adjust the force applied by the upper stitching wheel 32 to the bead apex 80. In addition, the spring may permit movement of the upper stitching wheel 32 in the Y-direction while in the operative configuration.

While the present embodiment utilizes a non-locking actuator 34 in conjunction with the upper arm 33 to automatically adjust the height of the upper stitching wheel 32, other arrangements are contemplated. For example, the upper stitching wheel 32 may freely move up and down in the Y-direction as desired with respect to the upper arm 33. In this example, the non-locking actuator may be disposed at the end of the upper arm 33 and directly engage with the upper stitching wheel 32. In this arrangement, once the upper arm 33 is lowered into the operative configuration, the actuator 34 is configured to apply a variable downward Y-direction force to the upper stitching wheel 32. When the downward force applied to the upper stitching wheel 32 by the actuator 34 is increased (such as by adding air to a pneumatic cylinder 37), the upper stitching wheel 32 moves down in the Y-direction and/or increases the pressure applied to the bead apex 80, depending on the profile of the given bead apex 80. When the downward force applied to the upper stitching wheel 32 by the actuator 34 is decreased (such as by removing air from a pneumatic cylinder 37), the upper stitching wheel 32 moves up in the Y-direction and/or decreases the pressure applied to the bead apex 80, depending on the profile of the given bead apex 80.

While the present embodiment describes only using the non-locking actuator 34 with the upper stitching wheel 32, a similar non-locking actuator 34 may also be used with the lower stitching wheel 42, as desired.

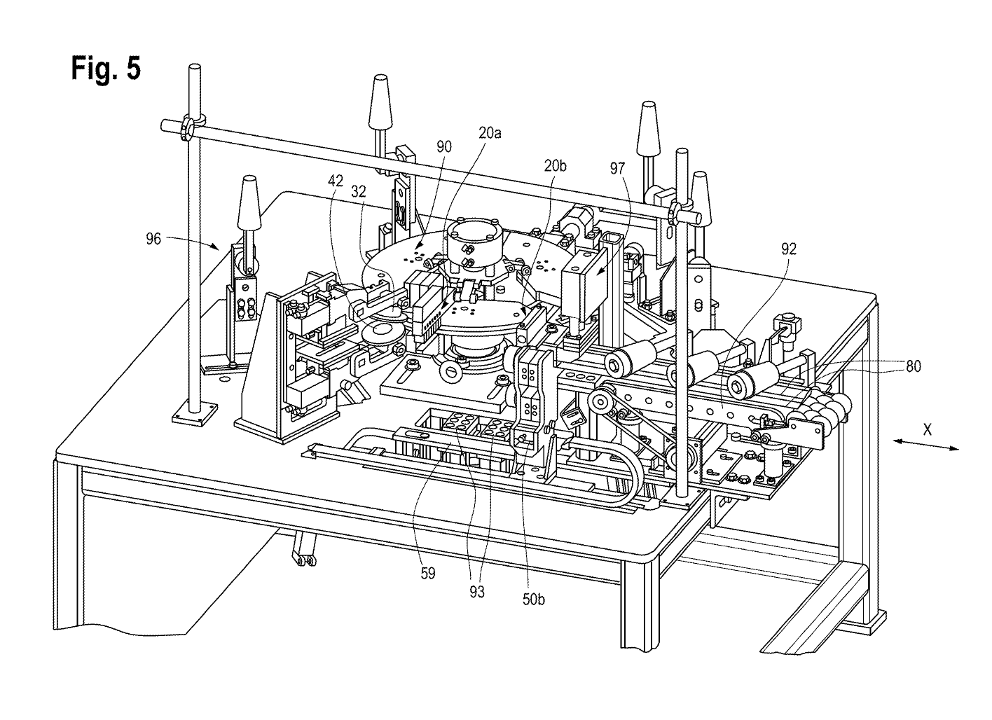

Referring now to FIG. 5, additional systems and methods are described that may be used in conjunction with the system 20 for stitching a bead apex to a bead ring that was described in FIGS. 1-4 above. In FIG. 5, the additional systems generally assist in allowing a consistent application of the bead apex 80 to a bead ring 82 that is held on a winder 90.

Before initiating the method, the upper and lower stitching wheels 32, 42 may be adjusted in the X-direction, Y-direction, and θ-direction to accommodate the specific size of the bead apex 80 and bead ring 82. The upper stitching wheel 32 may utilize a non-locking actuator 34 and be adjusted as described above with respect to FIGS. 1-4.

Once the upper and lower stitching wheels 32, 42 are properly adjusted, the method for stitching a bead apex to a bead ring can be initiated. First, a leading edge gripper 20a and a trailing edge gripper 20b are used to hold the bead apex 80 to the bead ring 82 while the stitching wheels 32, 42 couple them together. The leading edge gripper 20a is generally secured to the winder 90 and rotates with the winder 90, while the trailing edge gripper 20b stands apart from the winder 90 and is capable of longitudinal movement along a conveyor axis X, as shown in FIG. 5.

In one exemplary method, a conveyor 92, shown in FIG. 5, grabs and advances a bead apex 80 for a determined distance in an unclamped state without stress. Then, in a next step, the lower jaw 40 of the trailing edge gripper 20b moves from the open state to the closed state to engage a lower surface of the bead apex 80. Subsequently, the upper jaw 30 of the trailing edge gripper 20b moves from the open state to the closed state, and selected ones of a plurality of grippers 32 of the trailing edge gripper 20b move from the retracted state to the extended state to engage an upper surface of the bead apex 80. At this time, the leading edge 81 of the bead apex 80 is secured within the trailing edge gripper 20b.

In a next step, the trailing edge gripper 20b traverses towards the winder 90, e.g., by moving a frame 50b of the trailing edge gripper 20b longitudinally along a rail 59. At the same time the trailing edge gripper 20b traverses towards the winder 90, the conveyor 92 is left on to reduce stresses and stretch of the bead apex 80 that may be incurred by the conveyor 92 moving slower than the trailing edge gripper 20b. A ratio of speed of the trailing edge gripper 20b moving along the rail 59 to speed of the conveyor 92 may be adjusted to reduce imposition of stress to the bead apex 80.

As the trailing edge gripper 20b traverses towards the winder 90, one or more support tables 93 may be selectively deployed, from a lowered position shown in FIG. 5 to a raised position at a height approximate to the bead apex travel path, to provide support to the bead apex 80 as it travels in the longitudinal direction. The support tables 93 begin in a lowered position so they do not interfere with movement of the frame 50b and the lower jaw 40 of the trailing edge gripper 20b in a direction towards the winder 90, and once the trailing edge gripper 20b has passed the support tables 93, the tables 93 are raised to portions that support the bead apex 80 where it is suspended between the trailing edge gripper 20b and the conveyor 92.

When the trailing edge gripper 20b approaches a tangent point of a bead ring disposed on a periphery of the winder 90, the winder 90 begins to rotate. After the tangent point of the bead ring is reached, the trailing edge gripper 20b no longer moves longitudinally and the winder 90 is no longer rotated. With these components stationary, the lower jaw 40 of the leading edge gripper 20a moves from the open state to the closed state to engage a lower surface of the bead apex 80. Subsequently, the upper jaw 30 of the leading edge gripper 20a moves from the open state to the closed state, and selected ones of the plurality of grippers 32 of the leading edge gripper 20a move from the retracted state to the extended state to engage an upper surface of the bead apex 80. At this time, the leading edge 81 of the bead apex 80 is secured within the leading edge gripper 20a. Further, at this time, the grippers 32 of the trailing edge gripper 20b are retracted, and the upper and lower jaws 30 and 40 of the trailing edge gripper 20b each move from the closed to open states, thereby freeing the bead apex 80 from engagement with the trailing edge gripper 20b. The trailing edge gripper 20b then moves back towards its starting position.

In a next step, the winder 90 begins to rotate in a circumferential direction. Optionally, one or more additional support tables 53 may be deployed to further support the bead apex 80 as it is advanced by rotation of the winder 90.

The winder 90 then stops after the leading edge gripper 20a reaches a position beyond stitching wheels 32, 42. The stitching wheels 32, 42 may be provided in accordance with the system 20, as described in detail in FIGS. 1-4 above. Once the upper and lower stitching wheels 32, 42 are in contact with the bead apex 80, the winder 90 will resume circumferential rotation, as the conveyor 92 continues to feed the extruded bead apex 80. During this stage, the stitching wheels 32, 42 apply pressure to the bead apex 80 and apex ring 82, thereby securing the bead apex 80 circumferentially about the bead ring 82. During the process, one or more anti-cup rollers 96, shown in FIG. 5, may be positioned or otherwise activated for support in order to keep the bead apex 80 from cupping. A ratio of speed of the leading edge gripper 20a moving about the winder 90 to speed of the conveyor 92 may be adjusted to reduce imposition of stress to the bead apex 80 while it is being advanced around the winder 90 and secured to the bead ring 82.

At a programmable and predetermined degree of rotation, the winder 90 will cease to circumferentially rotate in preparation for a cutting position. When the winder 90 stops, the conveyor 92 is operable to pay out a given amount of the bead apex 80, in order to remove potential stresses within the bead apex that has yet to be applied to the bead ring.

In a next step, the trailing edge gripper 20b is once again actuated to engage the bead apex 80 by closing the lower jaw 40 and then the upper jaw 30, and extending at least one of the plurality of grippers 32, as explained in detail above. At this time, a knife 97 is actuated to cut the bead apex 80 and create a trailing edge of the bead apex 80. It is noted that the cutting by the knife 97 occurs under minimal, if any, stress being applied to the bead apex 80. With the trailing edge gripper 20b movement temporarily halted, the winder 90 is rotated circumferentially a programmed number of degrees in order to re-tension to the bead apex 80, i.e., the leading edge of the bead apex 80 held by the leading edge gripper 20a is rotated circumferentially a distance while the trailing edge of the bead apex 80 held by the trailing edge gripper 20b is held stationary near the knife 97. Advantageously, this sequence of movement of components reduces the phenomena known as “dog-ear” bending, which may be undesirable.

Once the bead apex 80 is under tension, the winder 90 continues to move circumferentially while the trailing edge gripper 20b is then advanced along the rail 59, until a time that the leading edge gripper 20a and the trailing edge gripper 20b are in close proximity to one another, thereby aligning the leading and trailing edges of the bead apex 80. For illustrative purposes, referring to FIG. 5, at this time the trailing edge gripper 20b would be positioned slightly clockwise to the leading edge gripper 20a. The seam between the leading and trailing edges of the bead apex 80 is then closed by application of appropriate pressure to one another. It is noted that, once the bases of the leading and trailing edges of the bead apex 80 are brought together, the trailing edge gripper 20b and the leading edge gripper 20a move in a synchronized manner towards one another, in order for the pressure-sensitive rubber of the bead apex 80 to be joined together. Then, the winder 90 continues to move circumferentially to allow the stitching wheels 32, 42 to complete the bonding of the bead apex 80 to the bead ring 82. Subsequently, the leading and trailing edge grippers 20a and 20b each release the bead apex 80 by moving from their respective closed to open states, thereby releasing the finished bead apex. The winder 90 and leading and trailing edge grippers 20a and 20b then may move back to their respective starting positions in order to assemble a subsequent extruded bead apex 80.

If desired, a new bead apex 80a and bead ring 82a with a different height profile (such as the one shown in FIG. 4) may subsequently be used with the same method as described here. Because the upper stitching wheel 32 utilizes a non-locking actuator 34 as described above in FIGS. 1-4, the height of the upper stitching wheel 32 does not need to be adjusted, as it will automatically accommodate the different height of the bead apex 80a and bead ring 82a. However, if some adjustments to the amount of force applied to the bead apex 80a is necessary, an air pressure regulator or other device may adjust this force as desired.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A system for stitching a bead apex to a bead ring, the system comprising:
a frame;
an upper assembly coupled to the frame, wherein the upper assembly comprises an upper elongated member, an upper rotatable arm coupled to the upper elongated member, wherein the upper rotatable arm is rotatable about a first pivot point with respect to the upper elongated member, and an upper stitching wheel coupled to the upper rotatable arm; and
a lower assembly coupled to the frame, wherein the lower assembly comprises a lower elongated member, a lower rotatable arm coupled to the lower elongated member, wherein the lower rotatable arm is rotatable about a second pivot point with respect to the lower elongated member, and a lower stitching wheel coupled to the lower rotatable arm;
wherein the upper stitching wheel and lower stitching wheel comprise an operative configuration, wherein in the operative configuration the upper stitching wheel is configured to engage with a first surface of the bead apex and the lower stitching wheel is configured to engage with a second surface of the bead apex;
wherein the upper assembly further comprises a non-locking actuator coupled to the upper rotatable arm, wherein the non-locking actuator is configured to rotate the upper rotatable arm about the first pivot point to move the upper stitching wheel to the operative configuration, wherein the non-locking actuator is configured to permit movement of the upper stitching wheel in a Y-direction between at least a first position and a second position while in the operative configuration.

2. The system of claim 1, wherein:
in the operative configuration, the upper and lower stitching wheels are rotated towards each other; and
the upper and lower stitching wheels further comprise a released configuration, wherein in the released configuration the upper and lower stitching wheels are rotated away from each other.

3. The system of claim 2, wherein:
the upper stitching wheel is adjustable in an X-direction and a θ-direction while in the released configuration, wherein the upper stitching wheel is locked and not adjustable in the X-direction and the θ-direction while in the operative configuration; and
the lower stitching wheel is adjustable in an X-direction, a Y-direction, and a θ-direction while in the released configuration, wherein the lower stitching wheel is locked and not adjustable in the X-direction, the Y-direction, and the θ-direction while in the operative configuration.

4. The system of claim 3, wherein:
the non-locking actuator comprises a pneumatic cylinder, wherein introduction of a gas into the pneumatic cylinder moves the upper stitching wheel from the released configuration to the operative configuration and removal of the gas from the pneumatic cylinder moves the upper stitching wheel from the operative configuration to the released configuration.

5. The system of claim 4, wherein:
in the operative configuration, the pneumatic cylinder is configured to permit movement of the upper stitching wheel in the Y-direction between at least the first position and the second position.

6. The system of claim 5, further comprising:
an air pressure regulator, wherein the air pressure regulator is configured to control the amount of the gas introduced into the pneumatic cylinder and removed from the pneumatic cylinder.

7. The system of claim 1, wherein:
the non-locking actuator comprises a pneumatic cylinder, wherein the pneumatic cylinder is configured to permit movement of the upper stitching wheel in the Y-direction between at least the first position and the second position.

8. The system of claim 7, wherein:
the upper stitching wheel is locked and not adjustable in the X-direction and the θ-direction while in the operative configuration.

9. The system of claim 1, wherein:
the non-locking actuator is a first non-locking actuator; and
the lower assembly further comprises a second non-locking actuator coupled to the lower rotatable arm, wherein the second non-locking actuator is configured to rotate the lower rotatable arm to move the lower stitching wheel to the operative configuration, wherein the second non-locking actuator is configured to permit movement of the lower stitching wheel in the Y-direction between at least a third position and a fourth position while in the operative configuration.

10. The system of claim 1, wherein:
the non-locking actuator comprises a spring, wherein the spring is configured to permit movement of the upper stitching wheel in the Y-direction between at least the first position and the second position.

11. The system of claim 10, wherein:
the spring is adjustable to apply a varying force to the upper rotatable arm.

12. The system of claim 2, wherein:
the non-locking actuator comprises a hydraulic cylinder, wherein introduction of a fluid into the hydraulic cylinder moves the upper stitching wheel from the released configuration to the operative configuration and removal of the fluid from the hydraulic cylinder moves the upper stitching wheel from the operative configuration to the released configuration.

13. The system of claim 1, wherein:
the non-locking actuator comprises a hydraulic cylinder, wherein the hydraulic cylinder is configured to permit movement of the upper stitching wheel in the Y-direction between at least the first position and the second position.

14. A system for stitching a bead apex to a bead ring, the system comprising:
a frame;
an upper assembly coupled to the frame, wherein the upper assembly comprises an upper elongated member, an upper rotatable arm coupled to the upper elongated member, wherein the upper rotatable arm is rotatable about a first pivot point with respect to the upper elongated member, and an upper stitching wheel coupled to the upper rotatable arm; and
a lower assembly coupled to the frame, wherein the lower assembly comprises a lower elongated member, a lower rotatable arm coupled to the lower elongated member, wherein the lower rotatable arm is rotatable about a second pivot point with respect to the lower elongated member, and a lower stitching wheel coupled to the lower rotatable arm;
wherein the upper assembly further comprises an actuator, wherein the actuator is configured to apply a variable downward Y-direction force to the upper stitching wheel, wherein when the downward force applied to the upper stitching wheel by the actuator is increased, the upper stitching wheel is configured to move down in the Y-direction, wherein when the downward force applied to the upper stitching wheel by the actuator is decreased, the upper stitching wheel is configured to move up in the Y-direction.

15. The system of claim 14, wherein:
the actuator comprises a pneumatic cylinder, wherein introduction of a gas into the pneumatic cylinder increases the downward force applied by the actuator to the upper stitching wheel, and removal of the gas from the pneumatic cylinder decreases the downward force applied by the actuator to the upper stitching wheel.

16. A method for adjusting the height of a stitching wheel, the method comprising:
providing a system comprising a frame, an upper assembly coupled to the frame, and a lower assembly coupled to the frame, wherein the upper assembly comprises an upper elongated member, and upper rotatable arm coupled to the upper elongated member, wherein the upper rotatable arm is rotatable about a first pivot point with respect to the upper elongated member, and an upper stitching wheel coupled to the upper rotatable arm, wherein the lower assembly comprises a lower elongated member, a lower rotatable arm coupled to the lower elongated member, wherein the lower rotatable arm is rotatable about a second pivot point with respect to the lower elongated member, and a lower stitching wheel coupled to the lower rotatable arm;
moving the upper stitching wheel from a released configuration to an operative configuration by rotating the upper rotatable arm with a non-locking actuator, wherein in the operative configuration the upper stitching wheel is configured to engaged with a first surface of a bead apex; and
adjusting the height of the upper stitching wheel while the upper stitching wheel is in the operative configuration.

17. The method of claim 16, further comprising:
moving the lower stitching wheel from a released configuration to an operative configuration, wherein in the operative configuration the lower stitching wheel is configured to engaged with a second surface of the bead apex.

18. The method of claim 17, further comprising:
introducing a first bead apex having a first profile height, wherein in a first position the upper stitching wheel engages the first surface of the first bead apex while in the operative configuration;
removing the first bead apex from engagement with the upper stitching wheel; and
introducing a second bead apex having a second profile height, wherein in a second position the upper stitching wheel engages a second surface of the second bead apex while in the operative configuration, wherein the non-locking actuator permits movement of the upper stitching wheel between the first and second positions while in the operative configuration.

19. The method of claim 16, wherein:
the non-locking actuator comprises a pneumatic cylinder, wherein introduction of a gas into the pneumatic cylinder moves the upper stitching wheel from the released configuration to the operative configuration and removal of the gas from the pneumatic cylinder moves the upper stitching wheel from the operative configuration to the released configuration.

20. The system of claim 19, wherein:
in the operative configuration, the pneumatic cylinder is configured to permit adjustment of the height of the upper stitching wheel.
